(19) United States
(12) Patent Application Publication
(10) Pub. No.: US 2025/0139408 A1
(43) Pub. Date: May 1, 2025

(54) PERFORMING SEGMENTED INFERENCE OPERATIONS OF A MACHINE LEARNING MODEL

(71) Applicant: Google LLC, Mountain View, CA (US)

(72) Inventor: Dong Hyuk Woo, Mountain View, CA (US)

(21) Appl. No.: 18/683,140

(22) PCT Filed: Sep. 17, 2021
(86) PCT No.: PCT/US2021/050975

§ 371 Date: Feb. 12, 2024

(51) Int. Cl. G06N 3/045

(52) U.S. Cl. CPC G06N 3/045

(57) ABSTRACT

Methods, systems, and apparatus, including computer programs encoded on computer storage media, for performing inference operations of machine learning models, are described in this document. In one aspect, the method includes receiving data representing a first machine learning model that includes inference operations. An estimated duration for the system to perform the inference operations is obtained. A priority time period reserved for performing priority inference operations of a priority machine learning model during each occurrence of a recurring time window is obtained. A remaining time period of each occurrence of the recurring time window that remains after reserving the priority time period is determined. A determination is made that the estimated duration is greater than the remaining time period. In response, the first machine learning model is partitioned into a group of sub-models. The hardware processing unit(s) perform inference operations of a sub-model during the remaining time period.

### TECHNICAL FIELD

This specification relates to data processing, machine learning, and performing segmented inference operations of a machine learning model.

### BACKGROUND

Machine learning models are models trained on experience (e.g., historical data) to learn patterns and make predictions for data sets, events, and systems. Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of network parameters.

In general, neural networks with deeper layers and larger layer size usually outperform their shallower and smaller counterparts after being trained, e.g., when applied for image detection or natural language processing related tasks. Larger and deeper neural networks inherently have a larger number of parameters, and some may be categorized as giant neural networks. A giant neural network is a neural network with many network parameters, e.g., 1 million parameters, 10 million parameters, 500 million parameters, or 2 billion or more parameters.

The network parameters for a neural network are values that impact the operations performed by the neural network and that are adjusted as part of training. For example, the network parameters can include values of weight matrices and, in some cases, bias vectors of the network layers of the neural network.

The hyperparameters of a neural network are values that are not modified by the training process. The hyperparameters can include values that impact how the values of the network parameters are updated by the training process e.g., the learning rate or other update rule that defines how the gradients computed during backpropagation are used to update the network parameter values, objective function values, e.g., entropy cost, weights assigned to various terms of the objective function, and so on.

### SUMMARY

According to an aspect, a method performed by a system including a host and one or more hardware processing units configured to perform inference operations of multiple machine learning models. The method includes receiving, at the host, data representing a first machine learning model that includes inference operations for processing an input to generate a first inference output; obtaining a first estimated duration for the system to perform the inference operations of the first machine learning model for processing the input to generate the first inference output; identifying a priority time period reserved for performing priority inference operations of a priority machine learning model during each occurrence of a recurring time window in which the one or more hardware processing units perform at least a portion of the inference operations of the multiple machine learning models; determining a first remaining time period of each occurrence of the recurring time window that remains after reserving the priority time period for performing the priority inference operations; determining whether the first estimated duration is greater than the first remaining time period; in response to determining that the first estimated duration is greater than the first remaining time period, partitioning the first machine learning model into a first group of sub-models that have respective estimated durations that are less than or equal to the first remaining time period, where each sub-model of the first group of sub-models includes a respective portion of the inference operations of the first machine learning model; and performing, by the one or more hardware processing units, inference operations of a sub-model in the first group of sub-models during the first remaining time period of an occurrence of the recurring time window.

The subject matter described in this specification can be implemented in particular embodiments so as to realize one or more of the following advantages. The techniques described in this specification can reduce jitter for data communication. The term “jitter” throughout the specification can broadly represent time delay during transferring data packet over a network connection. The time delay can be uneven, for example, a first packet can arrive at a device or a host within a 30-milliseconds (ms) delay and a second packet can arrive within a 40-ms delay. The jitter for data communication can be caused by transferring data packet of different sizes. The jitter can also be caused by waiting time across different computations when a system processes input data periodically received by the system.

More specifically, a system that performs the described techniques can determine a level of priority for multiple machine learning models and rank the multiple machine learning models based on the level of priority. For example, the high priority machine learning models can correspond to tasks such as face detection for a camera application on an edge device. The system can prioritize inference requests for machine learning models with a high priority level and ensure processing each frame of the received inputs to these prioritized machine learning models during each occurrence of a recurring time window. The recurring time window includes a time period for the system (e.g., a circuit or multiple hardware processing units) to perform operations within each cycle. Given that, the system can generate inference outputs for these prioritized machine learning models in time to reduce the jitter for data communication.

In addition, the techniques described in this specification can improve the efficiency of performing inference operations of one or more machine learning models. A system performing the described techniques can ensure performing inference operations associated with high priority tasks within each cycle by reserving time of each cycle for the high priority tasks. The system can determine a respective remaining time period for each recurring time window by subtracting the reserved time for high priority tasks. The system can partition lower priority models that may be determined to take up the entire remaining time period or even exceed the remaining time period into multiple sub-models and distribute the sub-models to respective groups of hardware processing units, distribute them to be processed across multiple cycles, or both.

In particular, the system can obtain an estimated duration (e.g., an estimated time period) to perform inference operations specified by a machine learning model at a low level of priority, and determine, for each cycle, whether to partition the machine learning model into multiple sub-models such that each of the multiple sub-models has a respective estimated duration that is less than or equal to a remaining time period of the recurring time window in the cycle. The system can arrange and distribute the multiple sub-models into one or more time windows and process them using respective hardware processing units. The remaining time period of each recurring time window is substantially utilized for performing inference operations of the sub-models, which can reduce idle time for each recurring time window and improve the computation efficiency.

The term “inference operations” throughout the specification can broadly represents operations specified in a corresponding machine learning model with parameters trained to process an input. The inference operations can include linear, non-linear operations, or both. For a machine learning model that is a trained neural network, inference operations can include nodal operations specified in each node of each network layer in the neural network trained for processing particular inputs.

Moreover, the techniques described in this specification can provide optimized quality of service (QoS) and enhance user experience. As described above, a system performing the techniques can determine a level of priority of each machine learning model and ensure the inference operations of the prioritized machine learning models are performed first or within each recurring time window. The system can also partition large machine learning models with low priority levels into multiple sub-models, and perform inference operations of the multiple sub-models over the course of multiple occurrences (e.g., cycles) of the recurring time window. A runtime controller of the system can determine how to distribute the high-priority machine learning models and multiple sub-models of different low-priority machine learning models into different cycles of the recurring time window. The runtime controller is also configured to manage multi-pass inferences through the sub-models distributed in one or more cycles of the recurring time window. Therefore, the data traffic is optimized, idle time of waiting for inputs or intermediate outputs is reduced, and the overall computation time is reduced for performing inference operations of multiple machine learning models. A recipient (e.g., a person or a device) of the system, when using one or more applications supported by the system, would therefore experience less time delay and obtain outputs faster compared to other systems using conventional techniques.

Furthermore, the system performing the described techniques is robust to different types of input and different sequences of input received at a different rate. The system can determine a size of a recurring time window for each cycle based on an input rate of the input data (e.g., number of input frames per second). The system can also determine a remaining time period for each time window after allocating priority time periods for performing inference operations of one or more priority machine learning models for processing the received frame of input.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example inference system for performing inference operations of machine learning models.

FIG. 2 illustrates an example process for performing inference operations of multiple machine learning models within different time windows in different scenarios.

FIG. 3A illustrates an example process for performing inference operations of multiple sub-models partitioned from a machine learning model.

FIG. 3B illustrates an example process for performing multi-pass inferences through multiple sub-models partitioned from a machine learning model.

FIG. 4 illustrates an example process for generating multiple sub-models from a machine learning model.

FIG. 5 illustrates an example process for determining a machine learning model to be partitioned into multiple sub-models.

### DETAILED DESCRIPTION

For better performance, machine learning models tend to have greater sizes with more sophisticated structures, for example, neural networks can have deeper layers and larger layer size, particularly for neural networks used for image processing tasks, e.g., object detection/recognition, or natural language processing. While larger machine learning models such as larger neural networks have brought remarkable quality improvements to several fields, scaling up the machine learning models can introduce significant practical challenges such as time window limits for processing sequences of inputs received at a particular frequency, memory limits for training, storing, and performing inference operations of the machine learning models, and memory bandwidth limits for transferring data and instructions between a host and accelerators.

For example, the bottleneck for training or performing inference operations of a neural network can be the memory limits for each individual computing device, i.e., devices having central processing units (“CPUs”), graphics processing units (“GPUs”), tensor processing units (“TPUs”). As another example, the bottleneck can be limited communication bandwidths between computing devices, e.g., data transferring rate between GPUs or TPUs and CPUs can be insufficiently fast compared to the computing rate of each individual computing device. Thus, the wait time for transferring data between devices can be comparable to, sometimes even much longer than, the run time on each computing device, leading to a slow training performance. As another example, the bottleneck can be bubble overhead on computing devices. Bubble overhead refers to the time that a succeeding computing device that is assigned a second part of the operations in a sequence spends waiting for the output from a preceding computing device that is assigned a first part of the operations in the sequence. That is, the input for the succeeding computing device to perform the second part of the operations is the output from the preceding computing device performing the first part of the operations. Given that, the succeeding computing device has to stay idle and wait until the preceding computing device completes the required computations. Therefore, the usage of each computing device can be low at time steps when the bubble overhead time is considerable, particularly if there is only one device operating at a time step.

Referring back to the time window limits, a bottleneck of performing inference operations specified in multiple machine learning models for processing a stream of inputs (e.g., multiple frames of input received at a particular time interval or frequency) is to process each frame of input through multiple machine learning models timely, e.g., preferably after receiving the frame of input and before receiving a succeeding frame of input. It can be difficult or even impossible in some cases to perform all inference operations of all the machine learning models within a single time window, especially if there are many models that are used to process the input and the time window is short, e.g., in the milliseconds. For example, one or more machine learning models can be large, and an estimated duration for performing all of these models can exceed an allocated recurring time window for the process. In some implementations, the system can determine a size of a recurring time window based on the rate or frequency of receiving each frame of input (e.g., frame per second (FPS)). Each occurrence of the recurring time window can be considered a processing cycle in which a frame (or other discrete instance of an input) is processed using the machine learning model(s). For example, each recurring time window can be 50 ms such that there are 20 processing cycles per second and 20 input frames are processed each second. Of course, other sizes of the recurring time windows, e.g., 30 ms, 100 ms, 1 second, etc., are also possible. For simplicity, the term “recurring time window” in the following specification is also referred to as “time window.”

Suppose the time window limits are not addressed. In that case, systems performing inference operations for processing multiple frames of input can have such problems as jitters during data transfer, considerable idle time for hardware accelerators, a slower rate of generating an inference output than the rate of receiving input, and lacking robustness to different types and streams of input data. The issues harm the computation efficiency and render the quality of service and user experience unsatisfactory. In addition, large, low priority machine learning models may dominate the time windows such that other higher priority machine learning tasks are not performed using the higher priority machine learning models, resulting in lower overall performance and errors caused by critical operations not being performed in a timely manner. For example, it may be critical for performance/error prevention that a particular machine learning model be used to process an input frame within each processing cycle. If a larger, lower priority machine learning models takes multiple processing cycles to complete, the particular machine learning model may not be used to process each input during each processing cycle, resulting in lower performance and/or errors.

Some techniques relating to partitioning large machine learning models into different portions and distributing different portions to different processors aim to solve the issues caused by memory limits, bandwidth limits, or both. These techniques can further apply pipeline methods to reduce bubble time for processors. However, these techniques do not address issues surfacing when processing each frame of a stream of input under a time constraint (e.g., a size of time window constraint).

The techniques described in this specification aim to solve the above-noted issues. In particular, given a time window constraint for processing a frame of inference input, the techniques described in this specification can determine a level of priority of multiple machine learning models and perform inference operations of machine learning models for processing the frame of input according to the priority levels. In other examples, there may be one or more identified high priority machine learning models that are to be used to process the input for each recurring time window. The techniques described in this document can perform the inference operations in ways that ensure that the one or more priority machine learning models are processed during each time window. Furthermore, the described techniques can partition a machine learning model (e.g., a large machine learning model) with a lower priority (e.g., a priority that indicates that the model does not have to be used each time window) into multiple sub-models such that an estimated duration for performing operations of each sub-model satisfies a remaining time period of the recurring time window. The system can further include a runtime controller configured to arrange and schedule performing inference operations specified in multiple machine learning models and sub-models on different processing units (e.g., in parallel) and/or across multiple time windows.

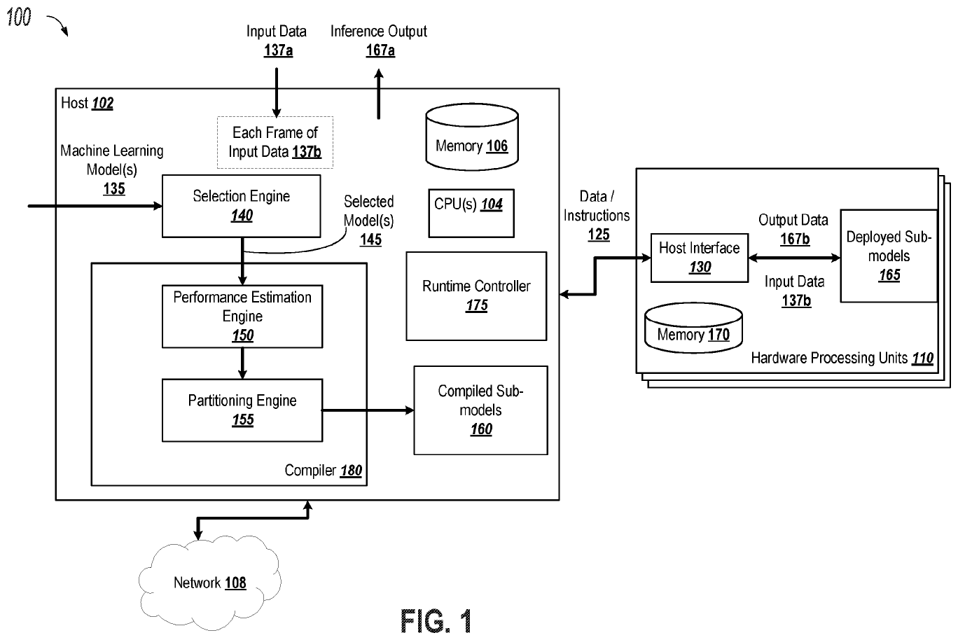

FIG. 1 shows an example inference system 100 for performing inference operations of machine learning models. The inference system 100 is an example of a system implemented on one or more computers in one or more locations, in which systems, components, and techniques described below can be implemented. Some of the components of the inference system 100 can be implemented as computer programs configured to run on the one or more computers.

The example inference system 100 can be implemented on various types of computing devices. For example, the inference system 100 can be part of a client device, such as a mobile device, e.g., smart phone or tablet computer, video streaming device, gaming console, or artificial intelligence assistant, e.g., smart speaker. In some implementations, the inference system 100 is implemented on a client device that includes a camera and the inference system 100 is configured to process images captured by the camera using machine learning models. In such examples, the inference system 100 can also be configured to process other types of inputs of the client device, such as sound (e.g., voice), video, or text input.

The inference system 100 can include a host 102 and multiple processing units 110. The term “host” throughout the specification can broadly represents a computer or a server configured to offer at least one of information resources, services, or applications to users or other devices coupled with the host in a network. The term “processing unit” throughout the specification can broadly represents suitable hardware components to perform particular operations, for example, the processing unit can include hardware machine learning accelerators or other types of processors, compute tiles, or cores.

The host 102 is communicatively coupled with the multiple hardware processing units 110, i.e., wired or wireless communication. The host 102 and the multiple processing units 110 can be located in one or more physical locations. In some implementations, the host 102 and the multiple processing units 110 can be integrated on a circuit or packaged into a single processor. For example, a single integrated circuit can include each of the processing units 110 and optionally the host 102. In another example, the processing units 110 can span multiple integrated circuits.

The inference system 100 can receive, at the host 102, data representing multiple machine learning model(s) 135 and input data 137a. The input data 137a can include multiple discrete units (e.g., frames) of input data to be processed by the multiple machine learning model(s) 135. Although the discrete units of input can be in various forms, the input is referred to as frames for brevity and ease of subsequent description. The inference system 100 can compile and deploy the multiple machine learning model(s) 135 onto one or more of the multiple processing units 110 to perform inference operations for processing each frame of input data 137b received from the host 102. The input data 137b corresponds to the input data 137a. That is, the host 102 can provide each frame of input data to the processing units 110. The inference system 100 can generate and output inference output 167a after processing the input data 137a through the machine learning model(s) 135. The inference output 167a can include one or more inferences for each frame of input data, e.g., a respective inference output by each machine learning model based on the frame of input data.

In some cases, a machine learning model may be configured to output an inference based on multiple frames. In such cases, the inference output 167a can include inferences generated based on multiple frames.

The host 102 can include a selection engine 140 configured to select, as non-priority machine learning models, one or more machine learning models from the multiple machine learning model(s) 135. The selection engine 140 can provide the selected machine learning model(s) 145 to a performance estimation engine 150 of the host 102. In some implementations, the selection engine 140 can be configured to estimate, for all machine learning model(s) 135, a recurring time window for processing a frame of input data 137a received at the host 102. In addition, the selection engine 140 can also determine a level of priority for each of the machine learning models for processing the frame of input data within the time window. For example, the selection engine 140 can determine one or more selected machine learning model(s) 145 based on the level of priority for each machine learning model.

The selected machine learning model(s) 145 are sometimes referred to as non-priority machine learning models in this specification, each having a respective priority level lower than priority machine learning models. The priority machine learning models can be machine learning models that have at least a threshold priority level, a specified number of the machine learning models having the highest priority levels, and/or the machine learning models that are required to be used to process each frame of input data 137b. In some implementations, there may be a single designated priority machine learning model that is ran for each frame, e.g., for each occurrence of the recurring time window, while in other implementations there may be multiple priority machine learning models.

The performance estimation engine 150 is configured to determine an estimated duration for performing inference operations of each of the selected machine learning model(s) 145. The performance estimation engine 150 is also configured to determine, for each machine learning model 145, whether the estimated duration satisfies a criterion, for example, whether the estimated duration is less than or equal to a remaining time period of a recurring time window. The host 102 can determine a remaining time period for a particular recurring time window based on the estimated duration for performing inference operations of one or more priority machine learning models within the time window. The remaining time period, recurring time window, and estimated duration are described in greater detail below.

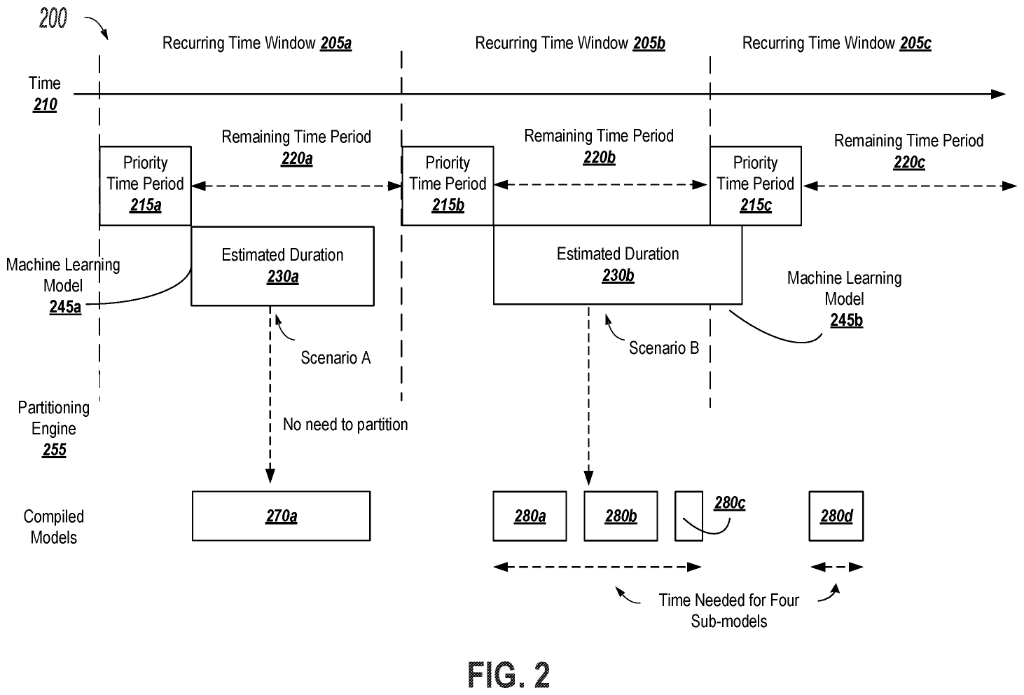

The performance estimation engine 150 can determine whether the estimated duration for performing inference operations of a machine learning model exceeds a remaining time period of a time window for processing the frame of input. In response to determining the estimated duration is greater than the remaining time period, the partitioning engine 155 can partition or segment the machine learning model into multiple sub-models. Each of the sub-models includes at least a non-overlapping portion of inference operations of the machine learning model. The partitioning engine 155 can further determine how to partition the machine learning model based on the recurring time window in which each frame of input data 137b is processed. The details of partitioning machine learning models are described in connection with FIG. 2.

In some implementations, a compiler 180 of the host 102 can include both the performance estimation engine 150 and the partitioning engine 155. In some implementations, the performance estimation engine 150 and/or the partitioning engine 155 are separate from the compiler 180. The compiler 180 is configured to compile the multiple sub-models partitioned by the partitioning engine 155 and other machine learning models that are not partitioned.

The host 102 can send data and instructions 125 to respective host interfaces 130 of the multiple hardware processing units 110. Each processing unit 110 can include a host interface 130. The data and instructions 125 include each frame of input data 137b, data representing the compiled sub-models 160 and other compiled machine learning models, data assigning and deploying different compiled models/sub-models on different processing units 110, and data arranging and scheduling performing inference operations of the deployed models on the assigned processing units 110. For example, the host 102 can distribute the compiled sub-models 160 and other machine learning models that are not partitioned to one or more of the hardware processing units 110.

The host interface 130 is used to coordinate and manage communication between the multiple processing units 110 and the host 102. Generally, the host interface 130 includes logic encoded in software and/or hardware in a suitable combination and operable to communicate with the host 102 and other components. More specifically, the host interface 130 can include software supporting one or more communication protocols associated with communications such that the network 120 and/or interface's hardware is operable to communicate physical signals within and outside of the processing units 110. Still further, the interface 130 can allow the hardware processing units 110 to communicate with the host 102 and/or the network 120 to perform different operations (e.g., inference operations described in this specification).

Each hardware processing unit 110 is configured to perform machine learning computations including inference operations of the assigned sub-models or models for processing each frame of the input data 137b and generate output data 167b after processing the frame of input data 137b using the model(s)/sub-model(s). The hardware processing units 110 can provide the output data 167 to the host 102, and the host 102 can output the received output data 167 as the inference output 167a in a manner of streaming or in a sequence. In some implementations, the host 102 can aggregate the output data 167b for one or more frames of input data 137a, and generate an inference output 167a for the multiple frames of input data 137a.

In some implementations, a computing device that includes the inference system 100 (or a different device) can include applications or application programming interfaces (APIs) that send requests to the inference system 100. For example, there can be multiple applications that each request that the inference system 100 use one or more corresponding machine learning models to process the input data 137a and provide one or more machine learning outputs, e.g., inference outputs 167, based on the processing.

In a particular example, a client device that includes a camera can include multiple applications or APIs that each have one or more respective machine learning models for processing images captured by the camera. Each application or API can request an inference output for each frame (e.g., static image) captured by the camera. In another example, the inference system 100 can be configured to provide the inference output 167 to each application or API, e.g., without requiring the outputs be requested.

The host 102 can include a runtime controller 175 configured to manage regular inferences of non-partitioned models and multi-pass inferences of partitioned models during the runtime. To manage multi-pass inferences, the runtime controller 175 can manage storing and fetching intermediate inputs and outputs from different memories (e.g., memory 106 or 170) on the host 102 or the multiple hardware processing units 110. The runtime controller 175 can schedule multiple inferences computations based at least on one of the input data 137a (e.g., frame of the input data 137b), the respective recurring time window for the input data 137a, the partitioned sub-models, or the computation capacity of hardware processing units 110.

In addition, the host 102 can include one or more central processing units (CPUs) 104. The CPUs 104 can provide processing to the host to perform certain control or logistics operations. In some implementations, the CPUs 104 can execute some processes during an inference. Generally, the CPUs 104 executes instructions and manipulates data to perform the operations of the host 102. Each CPU 104 can have a single core or multiple cores, with each core available to host 102 and execute an individual processing thread. Further, the number of, types of, and particular CPUs 104 used to execute the operations described herein can be dynamically determined based on a number of requests, interactions, and operations associated with the host 102.

Furthermore, the host 102 can include a memory 106. Memory 106 of the host 102 can represent a single memory or multiple memories. The memory 106 can include any memory or database module and can take the form of volatile or non-volatile memory including, without limitation, magnetic media, optical media, random access memory (RAM), read-only memory (ROM), removable media, or any other suitable local or remote memory component. The memory 106 can store various objects or data, including execution graphs, machine learning models, administrative settings, caches, applications, backup data, and any other appropriate information associated with the host 102, including any parameters, variables, algorithms, instructions, rules, constraints, or references thereto. While illustrated within the host 102, memory 106 or any portion thereof, including some or all of the particular illustrated components, can be located, in some instances, remote from the host 102 in some instances, including as a cloud application or repository, or as a separate cloud application or repository when the host 102 itself is a cloud-based system. In some examples, the data stored in memory 106 can be accessible, for example, via network 120, and can be obtained by particular applications or functionality of the hardware processing units 110.

Each processing unit 110 can include a hardware resource that performs operations independent of other devices. For example, each processing unit can include one or more processors, compute tiles, cores, etc. The processing units 110 can include GPUs and CPUs, as well as specialized hardware resources for efficiently performing certain operations, e.g., matrix multiplication, used in training a neural network. Examples of specialized hardware resources include Tensor Processing Units (“TPU”), Field Programmable Gate Arrays (“FGPA”), and Application Specific Integrated Circuits (“ASIC”).

Each hardware processing unit 110 can be heterogeneous, e.g., have multiple processing units of different types varying from device to device. Alternatively, each of the hardware processing unit 110 can include the same number and types of processing units.

In addition, hardware processing unit 110 can have a respective computational capability. That is, each hardware processing unit can have a different amount of memory 170, processing speed, or other architectural characteristics. Thus, some hardware processing units can perform operations that others cannot. For example, some operations can require a certain amount of memory that only particular hardware processing units have, or some processing units are configured only to perform a particular type of operation, e.g., inference operations.

Moreover, each of the hardware processing units 110 can access the memory 106 of the host 102 and have a memory unit 170. Each of the memory unit 170 can include any memory or database module and can take the form of volatile or non-volatile memory including, without limitation, magnetic media, optical media, random access memory (RAM), read-only memory (ROM), removable media, or any other suitable local or remote memory component. The memory unit 170 can store various objects or data, administrative settings, caches, applications, backup data, repositories storing dynamic information, and any other appropriate information associated with the hardware processing unit 110, including any parameters for inference, variables, algorithms, instructions, rules, constraints, or references. The memory unit 170 can include a shared memory, which is accessible by each tile of a hardware processing unit or across multiple hardware processing units. The shared memory can include a shared address space, which is used by each of the multiple tiles in the hardware processing units 110.

FIG. 2 illustrates an example process 200 for performing inference operations of multiple machine learning models within different time windows in different scenarios. For convenience, the process 200 is described as being performed by a system of one or more computers located in one or more locations. For example, an inference system, e.g., the system 100 of FIG. 1, appropriately programmed, can perform the process 200.

The inference system 100 of FIG. 1, as described above, can determine a time window for the system. More specifically, the time window can include a time period for the system 100 to perform inference operations within each computation cycle. The time window can be determined by the system 100 based on the rate of receiving each frame of input data, e.g., frames of input per second. For example, the time window can include a time period of 1 ms, 10 ms, 20 ms, 50 ms, 100 ms, or another appropriate time period. As described above, the time window can be a recurring time window. For example, another time window corresponding to another computation cycle can being immediately after a previous time window corresponding to a previous computation cycle ends.

As shown in FIG. 2, there are multiple time windows 205a, 205b, and 205c along the time axis 210. Each time window of 205a-c can include a time period for the system to perform inference operations for processing a frame of input data. Different time windows can have different lengths of time periods. Alternatively, one or more different time windows can share the same length time period.

The system 100 can include multiple machine learning models, each specified for performing particular inference tasks. For example, if the system 100 is used by a camera system, which is configured to take an image or a video (a time sequence of images) of a scene including one or more objects. The system 100 can include multiple machine learning models for different tasks and can perform inference operations of each of the machine learning models to process each frame of images received at a particular frequency (e.g., one image per 50 milliseconds) to complete the tasks. For example, the tasks can include automatically determining a focal point for the frame of an image, detecting objects in the frame of an image, detecting and recognizing human faces captured in the frame of an image, and determining a depth image of the frame of an image.

Preferably, the system 100 can perform inference operations of all machine learning models for processing a frame of input within a single time window or before receiving another input frame. However, when the system 100 has many tasks, which is estimated to need more time than a single time window. The system 100 is configured to arrange and schedule the order of performing inference operations so that each input frame is processed timely.

To make such an arrangement, the system 100 can determine a level of priority for each of the machine learning models. In general, the system 100 can determine the level of priority based on different aspects, such as whether an output of a machine learning model is provided as an input to another machine learning model (i.e., output dependency), a model size of a machine learning model, an approximate time and computation resources needed for performing inference operations of a machine learning model, and a level of sensitivity to latency, just to name a few examples.

As a more concrete example, a machine learning model can be determined by the system 100 to have a high priority level if one or more other machine learning models use the output from the machine learning model to process the image. As another example, a machine learning model (e.g., model for a camera viewfinder) that is sensitive to data latency can be determined by the system 100 to have a high priority level. As another example, a machine learning model configured to predict a depth image of an image frame can have a low level of priority if the model for generating a depth image can be large and require a longer processing time period and other machine learning models do not use the predicted output.

As another example, the system 100 can select a machine learning model as a priority machine learning model, or determine the priority level for machine learning models based on the task(s) performed by the machine learning models. In a particular example in the context of processing a text or a speech, the system can determine that a machine learning model associated with tasks of converting between text and speech (e.g., converting text into speech audio such as operations specified in a text-to-speech (TTS) model) has a high priority level. The system 100 can prioritize the operations specified in the TTS model based on the TTS model being a priority machine learning model. In this way, the system 100 can ensure that there is no (or minimal) “idle time” of awaiting outputs (e.g., audio frames) from the TTS model when performing operations of other models. By preventing this idle time the system 100 avoids “breakups” (i.e., audio buffer under-run) in audio when processing each frame of text inputs to generate a speech to the audience.

After determining a level of priority of the machine learning models, the system 100 can select one machine learning model that is large but having a low priority level (e.g., a priority level that is lower than the priority level of one or more other machine learning models). For example, the machine learning models 245a and 245b shown in FIG. 2, or the selected model(s) 145 of FIG. 1, can be considered the low priority machine learning model(s).

The system 100 can determine an estimated duration for performing inference operations of a machine learning model for processing the input. For example, the system 100 can determine an estimated duration for performing inference operations of a selected machine learning model with a low priority level. As shown in FIG. 2, the system 100 can determine an estimated duration 230a to perform inference operations of the machine learning model 245a for processing a frame of input, and another estimated duration 230b to perform inference operations of the machine learning model 245b for processing another frame of input.

In general, the system 100 can reserve a portion of each time window for performing inference operations of the priority machine learning models (e.g., the machine learning models classified as having a high level of priority). The portion of each time window reserved for priority machine learning models are also referred to as a “priority time period” for each time window, as described above. As shown in FIG. 2, the priority time period 215a, 215b, and 215c can represent the portion of each recurring time window 205a, 205b, and 205c reserved for the priority machine learning model(s). Meanwhile, the system 100 can determine the remaining time period for each time window based on the priority time period. For example, as shown in FIG. 2, the system 100 can determine a remaining time period of 220a, 220b, and 220c for each recurring time window 205a, 205b, and 205c, respectively.

The system 100 can then determine, by comparing the estimated duration for performing inference operations of a non-priority machine learning model (e.g., a machine learning model classified as having a low level of priority) and the remaining time period for the time window, whether the estimated duration is less than or equal to the remaining time period.

In response to determining the estimated duration for performing inference operations of the non-priority machine learning model is less than or equal to the remaining time period, the system 100 can schedule to perform operations of the non-priority machine learning model without partitioning the model into multiple sub-models. For example, and as shown by scenario A in FIG. 2, the system 100 determines the estimated duration 230a is less than the remaining time period 220a. In response, the partitioning engine 255, equivalent to the partitioning engine 155 of FIG. 1, does not partition the machine learning model 245a. Instead, the system 100 can directly compile the machine learning model (e.g., compiled model 270a) and perform the inference operations of the compiled model 270a after the priority time period 215a within the recurring time window 205a. Although in this example, each priority time period 215a-215c is shown as occurring at the beginning of each recurring time window 205a-205c, the priority time period 205a-215c can be located at the end or somewhere between the beginning and end in other implementations.

In some implementations, the system can determine to partition a non-priority machine learning model even when the estimated duration is determined to be less than or equal to the remaining time period.

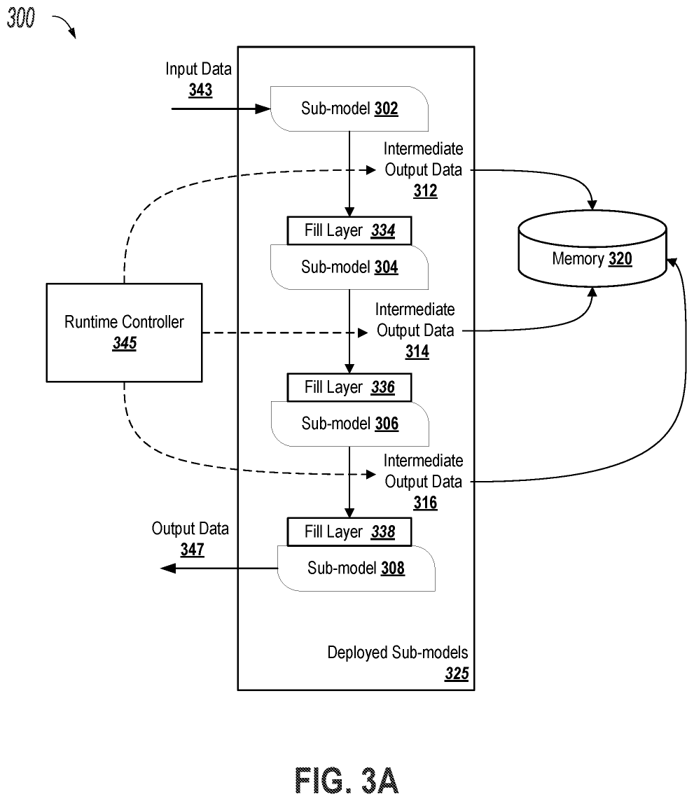

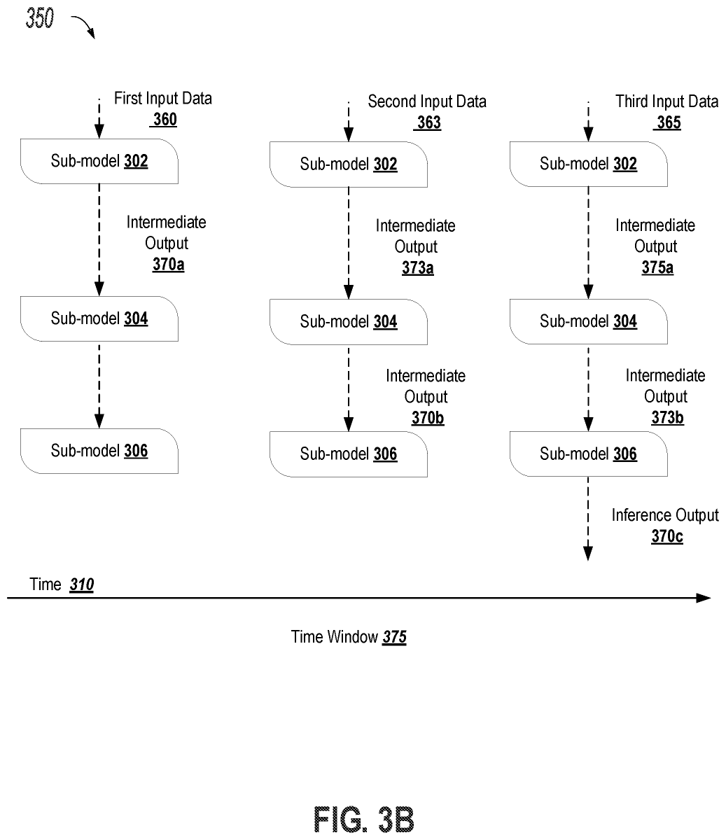

Alternatively, in response to determining the estimated duration for performing inference operations of the non-priority machine learning model is greater than to the remaining time period, the system 100 can partition the machine learning model into multiple sub-models and schedule to perform partial inference operations of the multiple sub-models according to a sequence. The sequence is determined based on the original machine learning model and how the machine learning model is partitioned. The details of generating multiple sub-models by partitioning a machine learning model are described in connection with FIG. 3A. For example, and as shown by scenario B in FIG. 2, the system 100 determines that the estimated duration 230b is greater than the remaining time period 220b. In response, the partitioning engine 255, which can be the same as or similar to the partitioning engine 155 of FIG. 1, partitions the machine learning model 345b into four sub-models. The system 100 further compiles the four sub-models and deploys the four compiled sub-models 280a, 280b, 280c, and 280d on the processing units 110, e.g., with each being assigned to a respective processing unit 110 or all to the same processing unit 110.

Preferably, the total time needed for performing inference operations of the compiled four sub-models should be substantially equal to the estimated duration 230b. However, because of the time spent on data storage, transfer, and inter-accelerator latency, the total time needs for the four sub-models can be greater than the estimated duration 230b. Therefore the system can arrange and schedule to perform the inference operations of sub-models 280a, 280b, and 280c in the recurring time window 205b after the priority time period 215a, and schedule to perform the inference operations of sub-model 280d in the recurring time window 205c after the priority time period 215c.

In situations where the system 100 schedules performing inference operations of the multiple sub-models across multiple time windows, the system 100, or particularly, the runtime controller 175 is configured to stored and fetch intermediate outputs and inputs from respective memory units 170 of the hardware processing units 110.

While there are only four sub-models 280a-d segmented from a machine learning model 245b, as shown in FIG. 2 for ease of illustration, it should be appreciated that the system 100 can partition a machine learning model into a different number of sub-models, for example, 2, 5, 10, and 20 sub-models. While the four sub-models 280a-d are scheduled across two time windows, as shown in FIG. 2 for ease of illustration, the system 100 can generally arrange and schedule performing inference operations of multiple sub-models across multiple, for example, three, five, and ten time windows. Other appropriate quantities of sub-models and time windows can also be used.

In some implementations, the system 100 can determine additional remaining time periods for other machine learning models after analyzing a first non-priority machine learning model. For example, system 100 can obtain a second estimated duration (not shown) to perform the inference operations of a second machine learning model for processing the input to generate a second inference output. The system 100 can also determine a second remaining time period (not shown) for one or more non-priority machine learning models after reserving (i) the priority time period for performing the priority inference operations of priority machine learning model(s) and (ii) at least a respective estimated duration for performing inference operations of a sub-model in first machine learning model(s) (e.g., machine learning models 245a and 245b that has been partitioned, scheduled, or both by the system 100). The system can follow similar steps described above to determine whether to partition the second non-priority machine learning model into a group of sub-models and schedule performing inference operations of the sub-models within the second remaining time period of the current recurring time window or across multiple recurring time windows.

FIG. 3A illustrates an example process 300 for performing inference operations of multiple sub-models partitioned from a machine learning model. For convenience, the process 300 is described as being performed by a system of one or more computers located in one or more locations. For example, an inference system, e.g., the system 100 of FIG. 1, appropriately programmed, can perform the process 300.

The deployed sub-models 325, as shown in FIG. 3A, can be equivalent to the compiled sub-models 160 of FIG. 1, or the compiled sub-models 280a-d of FIG. 2. The deployed sub-models 325 are partitioned from a selected machine learning model (e.g., a large machine learning model with a low level of priority) by the partitioning engine, equivalent to the partitioning engine 155 of FIG. 1. The system 100 can deploy the compiled sub-models onto one or more hardware processing units, e.g., machine learning accelerators, for performing inference operations to process the input data 343 and generate output data 347.

In some implementations, the machine learning models can include neural networks. Each neural network can include multiple network layers arranged in a sequence, where each network layer can include multiple parameters trained on particular training samples. The system can perform inference operations specified in each network layer according to the sequence to generate an output for an input. The different types and operations of neural networks are described in greater detail below.

When the large machine learning model with low priority is a neural network including multiple network layers, the system 100 (or the performance estimation engine 150 of FIG. 1) can obtain a respective estimated duration for performing inference operations of each network layer of the neural network. The system 100 can arrange and group up one or more network layers from the multiple network layers to form a sub-model (or a sub-network) of the neural network based on the estimated duration for each layer. The system 100 can sum up the estimated durations for all layers grouped in a sub-model to be the estimated duration for the sub-model. In some implementations, the system 100 can partition the neural network into multiple sub-models, each having a respective estimated duration. Alternatively, the system 100 can partition the neural network into multiple sub-models having a substantially same estimated duration.

To estimate a respective duration for each layer in a neural network, the system 100 can, for example, apply an analytical model to determine a respective duration for each operation of multiple nodal operations in a layer, and aggregate respective durations to estimate a respective layer duration. As another example, the system 100 can include a database from a large scale simulation-based data base to estimate layer durations. As another example, the system 100 can apply one or more machine learning models to predict data latency for each layer up to the entire neural network model and estimate respective layer durations based on the predicted data latency.

In general, the system 100 can partition the neural network into multiple sub-models, each having a respective number of network layers, so that the system can perform inference operations of the sub-models within a remaining time period of a time window or across multiple time windows, as described in FIG. 2.

To partition the neural network into multiple sub-models, the system 100 can determine, for each sub-model except for the last sub-model according to the sequence specified in the original neural network, the last layer of the sub-model as an output layer for the sub-model. The output from the output layer of a sub-model is an intermediate output of the neural network, which can serve as an intermediate input to a sub-model succeeding the sub-model according to the sequence.

Similarly, the system 100 can determine, for each sub-model except for the first sub-model according to the sequence specified in the original neural network, the first layer of the sub-model as an input layer or a fill layer of the sub-model. The fill layer of the sub-model can receive, as the intermediate input, an intermediate output from an output layer of a sub-model preceding the sub-model according to the sequence.

As an example and referring to FIG. 3A, the system 100 can partition and compile a machine learning model (e.g., a neural network) into multiple sub-models, e.g., 302, 304, 306, and 308. The system 100 can determine the first layer of the sub-model 304 as a fill layer 334 configured to receive intermediate output data 312 from the preceding sub-model 302. Similarly, the system 100 can determine the first layer of the sub-model 306 as a fill layer 336 configured to receive intermediate output data 314 from the preceding sub-model 304, and the first layer of the sub-model 308 as a fill layer 338 configured to receive intermediate output data 316 from the preceding sub-model 306.

Moreover, the system 100 can determine the last layer of the sub-model 302 as an output layer configured to generate intermediate output data 312. The system 100 can provide the intermediate output data 312 as an intermediate input to the fill layer 334 of the sub-model 304 succeeding the sub-model 302 according to the sequence specified in the neural network. Similarly, the system 100 can determine the last layer of the sub-model 304 as an output layer configured to generate intermediate output data 314, and determine the last layer of the sub-model 306 as an output layer configured to generate intermediate output data 316. The system 100 can provide the intermediate output data 314 as an intermediate input to the fill layer 336 of the sub-model 306, and provide the intermediate output data 316 as an intermediate input to the fill layer 338 of the sub-model 308.

During the runtime, as shown in FIG. 3A, when the system 100 is receiving frames of input data and processing each received frame of input, the runtime controller 345, equivalent to the runtime controller 175 of FIG. 1, can manage the data flow of the intermediate output data 312, 314, and 316. More specifically, the runtime controller 345 can determine whether to provide the intermediate output data to a succeeding sub-model, or store the intermediate output data in a memory unit. For example, assuming the system 100 schedules performing inference operations of the sub-model 302, 304, and 306 during the remaining time period of the first time window, and performing inference operations of the sub-model 308 during the remaining time period of the second time window. Thus, during the remaining time period of the first time window, the runtime controller 345 can determine and provide the intermediate output data 312 directly to the fill layer 334 of the sub-model 304, and provide the intermediate output data 314 directly to the fill layer 336 of the sub-model 306. The runtime controller 345, however, can first store the intermediate output data 316 in the memory 320. At or before the beginning of the remaining time period of the second time window, the runtime controller 345 can fetch or pre-fetch the intermediate output data 316 from the memory 320 and provide it to the fill layer 338 for performing inference operations within the remaining time period of the second time window. In general, the memory 320 can include any suitable memory accessible for hardware processing units assigned to perform inference operations of the deployed sub-models 325. For example, the memory 320 can be the multiple memory units 170 of hardware processing units 110 of FIG. 1. As another example, the memory 320 can be the memory 106 of the host 102 in FIG. 1, which is accessible for the hardware processing units 110.

As another example and in connection with FIG. 2, the runtime controller 345 can determine to store the intermediate output from the sub-model 280c in the time window 205b, and fetch and provide the intermediate output as an input to the sub-model 280d during the remaining time period 220c of the time window 205c.

FIG. 3B illustrates an example process 350 for performing multi-pass inferences through multiple sub-models partitioned from a machine learning model. For convenience, the process 350 is described as being performed by a system of one or more computers located in one or more locations. For example, an inference system, e.g., the system 100 of FIG. 1, appropriately programmed, can perform the process 350.

The system is configured to receive multiple frames of input data each at a time interval or a stream of multiple frames of input data, as described in FIG. 2. For example, the input data can be a stream of video having multiple frames of images or a set of multiple frames of images taken by a camera system at a particular time interval. The system 100 can assign the multiple machine learning models or partitioned sub-models to multiple hardware processing units 110, and perform multi-pass inference operations of the models to process one or more frames of the input within a time window.

More specifically, to perform multi-pass inference operations, the system 100 can perform inference operations by switching from priority machine learning models and non-priority machine learning models for processing frames of input. For example and in connection with FIG. 2, for a first frame of input received according to an order at a particular frequency, the system 100 can perform inference operations of one or more priority machine learning models for processing the first frame of input within the priority time period 215b of the recurring time window 205b. The system can then perform inference operations of sub-models 280a-c partitioned from a non-priority machine learning model 245b for processing the first frame of input in the remaining time period 220b.

Assuming the system 100 receives a second frame of input at the beginning of the time window 205c, the system 100 can perform inference operations of the one or more priority machine learning models for processing the second frame of input within the priority time period 215c of the time window 205c. After that, the system 100 can resume performing inference operations of the sub-model 280d from the non-priority machine learning model 245b for processing the first frame of input in the remaining time period 220c. The system 100 can then start to perform inference operations of sub-models 280a-d for the second frame of input across one or more time windows.

Referring back to FIG. 3B, the runtime controller 175 can determine when to store the intermediate output generated from a sub-model for a frame of input due to the system 100 needs to process a new frame of input data for-priority machine learning models or tasks, and when to resume processing the frame of the input in the same or one or more different time windows.

For example, and as shown in FIG. 3B, the system 100 can receive three frames of input data 365 in a single time window 375. It is noted that the example shown in FIG. 3B is for ease of illustration. However, the system 100 can also receive a different frame of input for a different time window, which does not change the methodology performed by the runtime controller 175.

During the remaining time period of the time window 375, the system 100 can receive first input data 360 (e.g., a first frame of a streaming data), and generate the intermediate output 370a by performing the inference operations of the sub-model 302 for processing the first input data 360.

Next, the system 100 can receive second input data 363, and generate the intermediate output 373a by performing the inference operations of the sub-model 302 for processing the second input data 363. Meanwhile, the system 100 can provide the intermediate output 370a to the sub-model 304, and generate the intermediate output 370b by performing the inference operations of the sub-model 304 for processing the first input data 360.

The system 100 can then receive third input data 365, and generate the intermediate output 375a by performing the inference operations of the sub-model 302 for processing the third input data 365. Meanwhile, the system 100 can provide the intermediate output 373a to the sub-model 304 and the intermediate output 373b to the sub-model 306. The system can generate the intermediate output 373b by performing the inference operations of the sub-model 304 for processing the second input data 363, and generate the intermediate output 370c (or inference output 370c, if the sub-model 306 is the last sub-model of the machine learning model according to the sequence) by performing the inference operations of the sub-model 306 for processing the first input data 360.

The runtime controller 175 can determine if any of the above-noted computations have to be performed in one or more time windows after the time window 375 for different reasons as described above. In response, the runtime controller 175 can store one or more intermediate outputs for corresponding frames of input to a memory unit, fetch the stored intermediate outputs, and provide them to corresponding sub-models once the system 100 resumes processing the corresponding input frames.

For example, the system can pause processing the intermediate output 373b in the time window 375. The runtime controller 175 can store the intermediate output 373b to a memory unit accessible for hardware processing units assigned to the sub-model 306. The runtime controller 175 can fetch the intermediate output 373b for performing the inference operations of the sub-model 306 to generate an inference output 370c for the first input data 360. Alternatively, the runtime controller 175 can store the memory address where the intermediate output 373b is stored. The hardware processing units assigned to the sub-model 306 can be instructed to fetch the stored output 373b from the memory address using one or more data buses.

Although not shown in FIG. 3B, it should be appreciated that the above-described multi-pass inferences method can be extended for performing inference operations of priority machine learning models within priority time period according to the computation requirements or limitations.

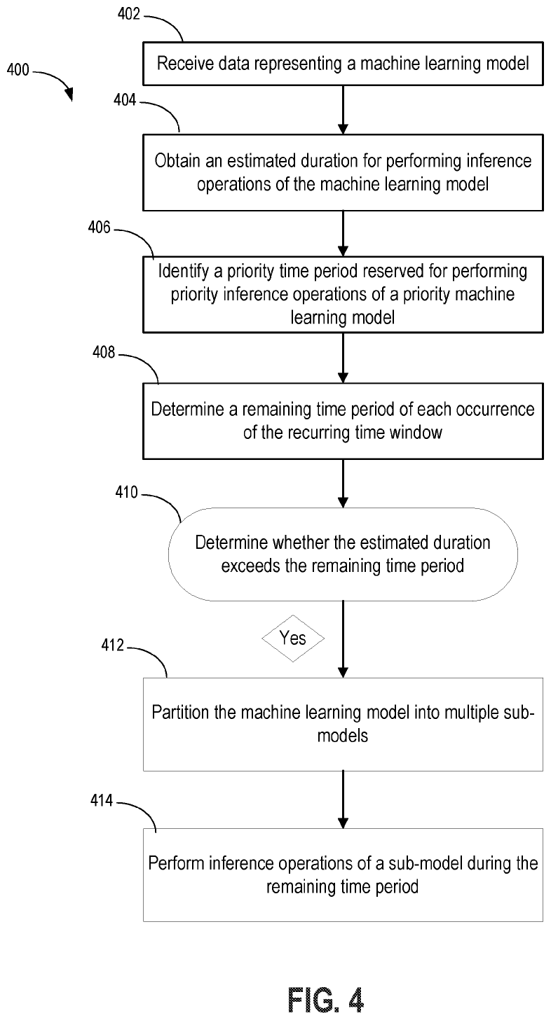

FIG. 4 illustrates an example process 400 for generating multiple sub-models from a machine learning model. For convenience, the process 400 is described as being performed by a system of one or more computers located in one or more locations. For example, an inference system, e.g., the system 100 of FIG. 1, appropriately programmed, can perform the process 400.

The system can include a host and one or more hardware processing units that are configured to perform inference operations of multiple machine learning models. The system is configured to receive multiple frames of input data in an order at a particular rate (e.g., frames per second).

The system can receive data representing a machine learning model (402). More specifically, the system can receive the data representing a first machine learning model at the host. The first machine learning model can include inference operations for processing an input to generate a first inference output. In some implementations, the machine learning model can include a neural network having multiple network layers with layer parameters.

The system can obtain an estimated duration to perform the inference operations of the first machine learning model for processing the input to generate the first inference output (404). The system can further estimate a respective time period to perform inference operations of each machine learning model of the multiple machine learning models received and stored in the system.

The system can identify a priority time period reserved for performing priority inference operations of a priority machine learning model (406). The system can determine a respective priority time period for each occurrence of a recurring time window. The one or more hardware processing units can perform at least a portion of the inference operations of the multiple machine learning models within each occurrence of the recurring window.

The system can determine a remaining time period of each occurrence of the recurring time period that remains after reserving the priority time period for performing the priority inference operations (408). Each recurring time window can include a respective time period comprising a respective remaining time period. Each remaining time period can include at least a portion of the time window available for the system to perform inference operations of one or more non-priority machine learning models.

The system can determine whether the estimated duration is greater than the remaining time period (410).

In response to determining the estimated duration is greater than the remaining time period, the system can partition the first machine learning model into a group sub-models (412). Each sub-model of the group of sub-models can include a respective portion of the inference operations represented in the first machine learning model. The system 100 can perform inference operations for one or more of the group of sub-models within the remaining time period across one or more the recurring time windows.

The system can perform, by the one or more processing units in the system, inference operations of a sub-model in the first group of sub-models during the remaining time period of an occurrence of the recurring time window (414).

In some implementations, the system can generate instructions at the host for assigning each of the group of sub-models to respective hardware processing units of the one or more hardware processing units. The system can schedule the one or more hardware processing units to perform respective portions of inference operations of the group of sub-models each assigned to corresponding hardware processing units to generate the first inference output.

In some implementations, the system can schedule performing inference operations associated with a first sub-model of the multiple sub-models in a remaining time period of a time window, and performing inference operations associated with a second sub-model of the multiple sub-models in another remaining time period of another time window. The first and second sub-models are ordered according to the sequence of sub-models partitioned from a machine learning model. The second sub-model succeeds the first sub-model according to the sequence. Each of the sub-models can include a respective portion of inference operations specified in the machine learning model.

The system can perform, according to the instructions of assignment and the sequence of group of sub-models arranged in the first machine learning model, respective inference operations of the first group of sub-models for processing the input on the assigned hardware processing units.

In some implementations, the system is configured to process input data, including multiple frames of input received in an order or a sequence or stream of input data frames. The system can process each frame of input received according to the order at a particular frequency. Given that, the time window can be automatically determined based on the rate or frequency of receiving each frame of the input.

In addition, the system can include a compiler. The compiler is configured to compile the multiple sub-models at the host and deploy each of the compiled sub-models to hardware processing units assigned to the compiled sub-models.

Moreover, a non-priority machine learning model selected and determined to be partitioned into multiple sub-models by the system can include a neural network. The neural network can include multiple network layers arranged in a sequence according to the neural network. The system can determine a respective estimated layer duration for each layer of the network layers required for the system to perform respective layer operations specified in the network layer to process a frame of input. The system can aggregate respective estimated layer durations for all the network layers to generate the estimated duration required for the system to perform all the inference operations specified in the neural network.

The system can partition the neural network into multiple sub-models, each of the multiple sub-models including a respective number of network layers arranged according to the sequence, and thus a respective estimated duration to perform inference operations.

The system can determine a respective fill layer for each sub-model except for the first sub-model according to the sequence. The respective fill layer is configured as an input layer for an associated sub-model such that an intermediate output generated from a preceding sub-model is provided to the sub-model as an input through the fill layer. The respective fill layer is the first layer of the respective number of network layers included in a corresponding sub-model.

The system is configured to perform multi-pass inference operations of one or more machine learning models. As described above, the input data can include a sequence of frames of input. The sequence of inputs can include a first input and a second input received at the host according to an order at a particular frequency.

To generate an inference output for processing the frames of input, the system can perform inference operations associated with a first sub-model of a partitioned non-priority model for processing the first input to generate a first intermediate output. The system can provide the first intermediate output as a first intermediate input, through a fill layer of a second sub-model, to a second sub-model succeeding the first sub-model according to the sequence specified in the machine learning model.

The system can then perform the inference operations associated with the first sub-model for processing the second input to generate a second intermediate output. At the same time, the system can perform inference operations associated with the second sub-model for processing the first intermediate input.

The system can further include a runtime controller. The runtime controller can be configured to control the data flow when the system performs the multi-pass inference operations. More specifically, the runtime controller can schedule performing inference operations of the multiple sub-models within one or more time windows. The runtime controller can store, at a memory unit in the system, an intermediate output generated by a sub-model of the multiple the sub-models for processing a frame of input. The runtime controller can further retrieve, from the memory unit in the system, the intermediate output as an intermediate input for another sub-model that succeeds the sub-model according to the sequence. The memory unit in the system can be accessible for hardware processing units assigned for the sub-models.

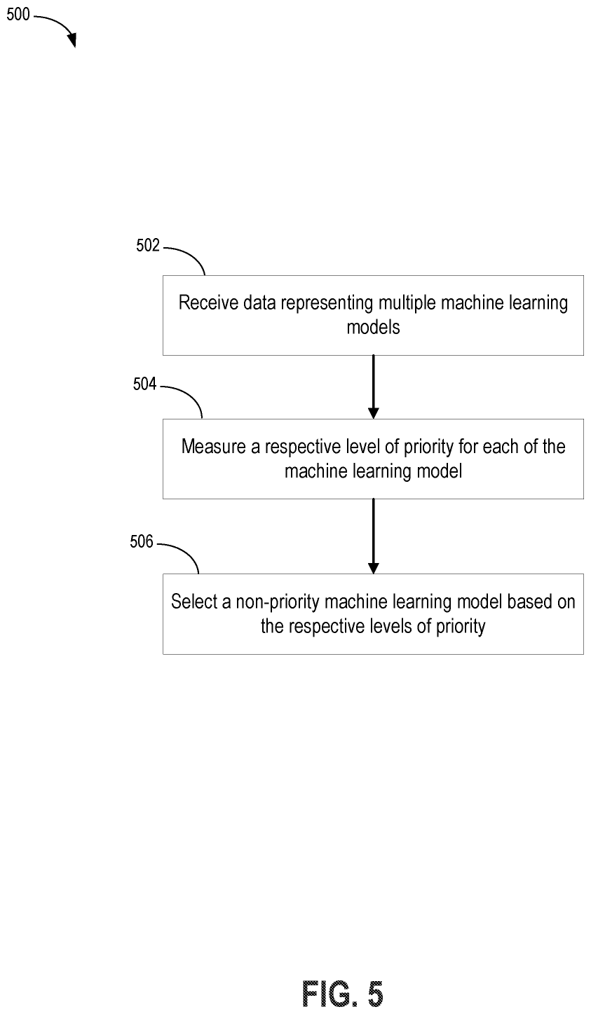

FIG. 5 illustrates an example process 500 for determining a machine learning model to be partitioned into multiple sub-models. For convenience, the process 500 is described as being performed by a system of one or more computers located in one or more locations. For example, an inference system, e.g., the system 100 of FIG. 1, appropriately programmed, can perform the process 500.

To select a machine learning model that is classified as a non-priority machine learning model, the system can receive data representing multiple machine learning models (502). Each of the multiple machine learning models is configured to implement a respective task and includes respective inference operations performed by the system for processing respective inputs. The tasks can include, for example, for images captured by a camera system, at least one of background detection, focal point detection, object detection, or face recognition. The task of background detection can further include generating a depth image for the captured image.

The system can measure a respective level of priority for each of the multiple machine learning models based on the characteristics of the respective tasks (504). The characteristics of the respective tasks can include the size of the machine learning model for performing a task, whether an output from a machine learning model for the task is used by other models as an input, or whether the machine learning model for the task is latency-sensitive.

The system can select, as a non-priority machine learning model, one machine learning model from the multiple machine learning models based on the respective levels of priority (506). For example, the system can select a machine learning model with a low-priority level as the selected non-priority machine learning model.

Implementations of the subject matter and the actions and operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, e.g., one or more modules of computer program instructions, encoded on a computer program carrier, for execution by, or to control the operation of, data processing apparatus. The carrier may be a tangible non-transitory computer storage medium. Alternatively or in addition, the carrier may be an artificially-generated propagated signal, e.g., a machine-generated electrical, optical, or electromagnetic signal that is generated to encode information for transmission to suitable receiver apparatus for execution by a data processing apparatus. The computer storage medium can be or be part of a machine-readable storage device, a machine-readable storage substrate, a random or serial access memory device, or a combination of one or more of them. A computer storage medium is not a propagated signal.

The term “neural network” encompasses all kinds of neural networks configured to perform all kinds of tasks.

In some cases, the neural network is configured to perform an image processing task, i.e., receive an input image and to process the input image to generate a network output for the input image. For example, the task may be image classification and the output generated by the neural network for a given image may be scores for each of a set of object categories, with each score representing an estimated likelihood that the image contains an image of an object belonging to the category. As another example, the task can be image embedding generation and the output generated by the neural network can be a numeric embedding of the input image. As yet another example, the task can be object detection and the output generated by the neural network can identify locations in the input image at which particular types of objects are depicted. As yet another example, the task can be image segmentation and the output generated by the neural network can assign each pixel of the input image to a category from a set of categories.

As another example, if the inputs to the neural network are Internet resources (e.g., web pages), documents, or portions of documents or features extracted from Internet resources, documents, or portions of documents, the task can be to classify the resource or document, i.e., the output generated by the neural network for a given Internet resource, document, or portion of a document may be a score for each of a set of topics, with each score representing an estimated likelihood that the Internet resource, document, or document portion is about the topic.

As another example, if the inputs to the neural network are features of an impression context for a particular advertisement, the output generated by the neural network may be a score that represents an estimated likelihood that the particular advertisement will be clicked on.

As another example, if the inputs to the neural network are features of a personalized recommendation for a user, e.g., features characterizing the context for the recommendation, e.g., features characterizing previous actions taken by the user, the output generated by the neural network may be a score for each of a set of content items, with each score representing an estimated likelihood that the user will respond favorably to being recommended the content item.

As another example, if the input to the neural network is a sequence of text in one language, the output generated by the neural network may be a score for each of a set of pieces of text in another language, with each score representing an estimated likelihood that the piece of text in the other language is a proper translation of the input text into the other language.

As another example, the task may be an audio processing task. For example, if the input to the neural network is a sequence representing a spoken utterance, the output generated by the neural network may be a score for each of a set of pieces of text, each score representing an estimated likelihood that the piece of text is the correct transcript for the utterance. As another example, the task may be a keyword spotting task where, if the input to the neural network is a sequence representing a spoken utterance, the output generated by the neural network can indicate whether a particular word or phrase (“hotword”) was spoken in the utterance. As another example, if the input to the neural network is a sequence representing a spoken utterance, the output generated by the neural network can identify the natural language in which the utterance was spoken.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the task can be a text to speech task, where the input is text in a natural language or features of text in a natural language and the network output is a spectrogram or other data defining audio of the text being spoken in the natural language.

As another example, the task can be a health prediction task, where the input is electronic health record data for a patient and the output is a prediction that is relevant to the future health of the patient, e.g., a predicted treatment that should be prescribed to the patient, the likelihood that an adverse health event will occur to the patient, or a predicted diagnosis for the patient.

As another example, the task can be an agent control task, where the input is an observation characterizing the state of an environment and the output defines an action to be performed by the agent in response to the observation. The agent can be, e.g., a real-world or simulated robot, a control system for an industrial facility, or a control system that controls a different kind of agent.

The neural network can have a set of parameters (“network parameters”) configured to process network inputs in accordance with the trainee parameters to generate an output for the particular task. The neural network can have any appropriate architecture that allows the neural network to receive network inputs of the type required by the particular task and to generate network outputs of the form required for the particular task. Examples of neural networks can include fully-connected neural networks, convolutional neural networks, recurrent neural networks, attention-based neural networks, e.g., transformers, and so on.

The term “data processing apparatus” encompasses all kinds of apparatus, devices, and machines for processing data, including by way of example a programmable processor, a computer, or multiple processors or computers. Data processing apparatus can include special-purpose logic circuitry, e.g., an FPGA (field programmable gate array), an ASIC (application-specific integrated circuit), or a GPU (graphics processing unit). The apparatus can also include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, an engine, a script, or code, can be written in any form of programming language, including compiled or interpreted languages, or declarative or procedural languages; and it can be deployed in any form, including as a stand-alone program or as a module, component, engine, subroutine, or other unit suitable for executing in a computing environment, which environment may include one or more computers interconnected by a data communication network in one or more locations.

A computer program may, but need not, correspond to a file in a file system. A computer program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

The processes and logic flows described in this specification can be performed by one or more computers executing one or more computer programs to perform operations by operating on input data and generating output. The processes and logic flows can also be performed by special-purpose logic circuitry, e.g., an FPGA, an ASIC, or a GPU, or by a combination of special-purpose logic circuitry and one or more programmed computers.

Computers suitable for the execution of a computer program can be based on general or special-purpose microprocessors or both, or any other kind of central processing unit. Generally, a central processing unit will receive instructions and data from a read-only memory or a random access memory or both. The essential elements of a computer are a central processing unit for executing instructions and one or more memory devices for storing instructions and data. The central processing unit and the memory can be supplemented by, or incorporated in, special-purpose logic circuitry.

Generally, a computer will also include, or be operatively coupled to receive data from or transfer data to one or more mass storage devices. The mass storage devices can be, for example, magnetic, magneto-optical, or optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, implementations of the subject matter described in this specification can be implemented on, or configured to communicate with, a computer having a display device, e.g., a LCD (liquid crystal display) monitor, for displaying information to the user, and an input device by which the user can provide input to the computer, e.g., a keyboard and a pointing device, e.g., a mouse, a trackball or touchpad. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser, or by interacting with an app running on a user device, e.g., a smartphone or electronic tablet. Also, a computer can interact with a user by sending text messages or other forms of message to a personal device, e.g., a smartphone that is running a messaging application, and receiving responsive messages from the user in return.

This specification uses the term “configured to” in connection with systems, apparatus, and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. For special-purpose logic circuitry to be configured to perform particular operations or actions means that the circuitry has electronic logic that performs the operations or actions.

Implementations of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:
Embodiment 1 is a method performed by a system including a host and one or more hardware processing units configured to perform inference operations of a plurality of machine learning models, the method comprising: receiving, at the host, data representing a first machine learning model, wherein the first machine learning model comprises inference operations for processing an input to generate a first inference output; obtaining a first estimated duration for the system to perform the inference operations of the first machine learning model for processing the input to generate the first inference output; identifying a priority time period reserved for performing priority inference operations of a priority machine learning model during each occurrence of a recurring time window in which the one or more hardware processing units perform at least a portion of the inference operations of the plurality of machine learning models; determining a first remaining time period of each occurrence of the recurring time window that remains after reserving the priority time period for performing the priority inference operations; determining whether the first estimated duration is greater than the first remaining time period; in response to determining that the first estimated duration is greater than the first remaining time period, partitioning the first machine learning model into a first group of sub-models that have respective estimated durations that are less than or equal to the first remaining time period, wherein each sub-model of the first group of sub-models includes a respective portion of the inference operations of the first machine learning model; and performing, by the one or more hardware processing units, inference operations of a sub-model in the first group of sub-models during the first remaining time period of an occurrence of the recurring time window.
Embodiment 2 is the method of embodiment 1, wherein generating the first inference output further comprises: generating instructions at the host for assigning each of the first group of sub-models to respective hardware processing units of the one or more hardware processing units, and performing, according to the instructions and a sequence of the first group of sub-models arranged in the first machine learning model, respective inference operations of the first group of sub-models for processing the input on the assigned hardware processing units.
Embodiment 3 is the method of embodiment 2, wherein performing the respective inference operations of the first group of sub-models further comprises scheduling, by the host, the one or more hardware processing units s to perform the respective inference operations of the first group of sub-models each assigned to corresponding hardware processing units to generate the first inference output.
Embodiment 4 is the method of any one of embodiments 1-3, further comprising compiling, by a compiler of the host, the first group of sub-models and deploying each of the compiled sub-models to the one or more hardware processing units.
Embodiment 5 is the method of any one of embodiments 1-4, wherein receiving data representing the first machine learning model further comprises: receiving data representing a plurality of machine learning models, each of the plurality of machine learning models being configured to implement a respective task and including respective inference operations to be performed by the system for processing the input; measuring a respective level of priority for each of the plurality of machine learning models based on characteristics of the respective tasks; and selecting, as the first machine learning model, one machine learning model from the plurality of machine learning models based on the respective levels of priority.
Embodiment 6 is method of any one of embodiments 1-5, further comprising: receiving data representing a second machine learning model, obtaining a second estimated duration for the system to perform the inference operations of the second machine learning model for processing the input to generate a second inference output; determining a second remaining time period of each occurrence of the recurring time window that remains after reserving (i) the priority time period for performing the priority inference operations and (ii) at least a respective estimated duration for performing inference operations of a sub-model in the first machine learning model; determining whether the second estimated duration is greater than the second remaining time period; in response to determining that the second estimated duration is greater than the second remaining time period, partitioning the second machine learning model into a second group of sub-models that have respective estimated durations that are less than or equal to the second remaining time period, wherein each sub-model of the second group of sub-models includes a respective portion of the inference operations of the second machine learning model; and performing, by the one or more processing units, inference operations of a sub-model of the second group of sub-models during the second remaining time period of an occurrence of the recurring time window.
Embodiment 7 is the method of embodiment 5 or 6, wherein the input includes an image frame of a plurality of image frames captured by a sensor; wherein each occurrence of the recurring time window corresponds to the image frame of the plurality of image frames; wherein the respective tasks includes at least one of background detection, focal point detection, object detection, or human face recognition; and wherein the characteristics of the respective tasks include at least a dependency of the respective tasks and respective estimated durations for performing the respective tasks by the one or more processing units in the system.
Embodiment 8 is the method of any one of embodiments 1-7, wherein the system is configured to perform inference operations of one or more machine learning models for processing a sequence of inputs, wherein each of the sequence of inputs is received at the host according to an order at a particular frequency, and wherein a time period of the recurring time window is determined based on the particular frequency.
Embodiment 9 is the method of any one of embodiments 1-7, wherein the first machine learning model comprises a neural network including multiple network layers arranged in a sequence, wherein obtaining the first estimated duration comprises: for each layer of the network layers, determining a respective estimated layer duration for the system to perform respective layer operations specified in the layer for processing the input; and aggregating the respective estimated layer durations for all network layers to obtain the first estimated duration.
Embodiment 10 is the method of embodiment 2 or 3, further comprising: performing inference operations associated with a first sub-model of the first group of sub-models according to the sequence in the first remaining time period of a first recurring time window of the plurality of recurring time windows, and performing inference operations associated with a second sub-model of the first group of sub-models that succeeds the first sub-model according to the sequence in the first remaining time period of a second recurring time window of the plurality of recurring time windows.
Embodiment 11 is the method of any one of embodiments of 1-7 and 9, wherein partitioning the first machine learning model comprising the neural network further comprises: partitioning the neural network into the first group of sub-models, each including a respective number of network layers arranged according to the sequence; and determining a respective fill layer for each sub-model of the first group of sub-models except for the first sub-model so that an intermediate output generated from another sub-model preceding the sub-model is provided to the sub-model as an input by the respective fill layer; wherein the respective fill layers each are the first layer of network layers included in a corresponding sub-model of the first group of sub-models.
Embodiment 12 is the method of any one of embodiments claim 1-11, wherein the input comprises a sequence of inputs including a first input and a second input received at the host according to an order, wherein generating the inference output further comprises: performing inference operations associated with a first sub-model according to the sequence for processing the first input to generate a first intermediate output; providing the first intermediate output as a first intermediate input, through a fill layer for a second sub-model, to the second sub-model that succeeds the first sub-model according to the sequence; and performing inference operations associated with the first sub-model according to the sequence for processing the second input to generate a second intermediate output, meanwhile, performing inference operations associated with the second sub-model for processing the first intermediate input.
Embodiment 13 is the method of any one of embodiments of 2, 3, and 10, wherein generating the first inference output further comprises: storing an intermediate output generated by a sub-model of the first group of sub-models for processing the input at a memory unit in the system; and retrieving, from the memory unit in the system, the intermediate output as an intermediate input for another sub-model that succeeds the sub-model according to the sequence.
Embodiment 14 is a system comprising one or more computers and one or more storage devices storing instructions that are operable, when executed by the one or more computers, to cause the one or more computers to perform the method of any one of embodiments 1 to 13.
Embodiment 15 is a computer storage medium encoded with a computer program, the program comprising instructions that are operable, when executed by data processing apparatus, to cause the data processing apparatus to perform the method of any one of embodiments 1 to 13.

While this specification contains many specific implementation details, these should not be construed as limitations on the scope of what is being or may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by a system including a host and one or more hardware processing units configured to perform inference operations of a plurality of machine learning models, the method comprising:
receiving, at the host, data representing a first machine learning model, wherein the first machine learning model comprises inference operations for processing an input to generate a first inference output;
obtaining a first estimated duration for the system to perform the inference operations of the first machine learning model for processing the input to generate the first inference output;
identifying a priority time period reserved for performing priority inference operations of a priority machine learning model during each occurrence of a recurring time window in which the one or more hardware processing units perform at least a portion of the inference operations of the plurality of machine learning models;
determining a first remaining time period of each occurrence of the recurring time window that remains after reserving the priority time period for performing the priority inference operations; determining whether the first estimated duration is greater than the first remaining time period;
in response to determining that the first estimated duration is greater than the first remaining time period, partitioning the first machine learning model into a first group of sub-models that have respective estimated durations that are less than or equal to the first remaining time period, wherein each sub-model of the first group of sub-models includes a respective portion of the inference operations of the first machine learning model; and
performing, by the one or more hardware processing units, inference operations of a sub-model in the first group of sub-models during the first remaining time period of an occurrence of the recurring time window.

2. The method of claim 1, wherein generating the first inference output further comprises:
generating instructions at the host for assigning each of the first group of sub-models to respective hardware processing units of the one or more hardware processing units, and
performing, according to the instructions and a sequence of the first group of sub-models arranged in the first machine learning model, respective inference operations of the first group of sub-models for processing the input on the assigned hardware processing units.

3. The method of claim 2, wherein performing the respective inference operations of the first group of sub-models further comprises:
scheduling, by the host, the one or more hardware processing units s to perform the respective inference operations of the first group of sub-models each assigned to corresponding hardware processing units to generate the first inference output.

4. The method of claim 1, further comprising:
compiling, by a compiler of the host, the first group of sub-models and deploying each of the compiled sub-models to the one or more hardware processing units.

5. The method of claim 1, wherein receiving data representing the first machine learning model further comprises:
receiving data representing a plurality of machine learning models, each of the plurality of machine learning models being configured to implement a respective task and including respective inference operations to be performed by the system for processing the input;
measuring a respective level of priority for each of the plurality of machine learning models based on characteristics of the respective tasks; and
selecting, as the first machine learning model, one machine learning model from the plurality of machine learning models based on the respective levels of priority.

6. The method of claim 1, further comprising:
receiving data representing a second machine learning model,
obtaining a second estimated duration for the system to perform the inference operations of the second machine learning model for processing the input to generate a second inference output;
determining a second remaining time period of each occurrence of the recurring time window that remains after reserving (i) the priority time period for performing the priority inference operations and (ii) at least a respective estimated duration for performing inference operations of a sub-model in the first machine learning model;
determining whether the second estimated duration is greater than the second remaining time period;
in response to determining that the second estimated duration is greater than the second remaining time period, partitioning the second machine learning model into a second group of sub-models that have respective estimated durations that are less than or equal to the second remaining time period, wherein each sub-model of the second group of sub-models includes a respective portion of the inference operations of the second machine learning model; and
performing, by the one or more processing units, inference operations of a sub-model of the second group of sub-models during the second remaining time period of an occurrence of the recurring time window.

7. The method of claim 5, wherein the input includes an image frame of a plurality of image frames captured by a sensor;
wherein each occurrence of the recurring time window corresponds to the image frame of the plurality of image frames;
wherein the respective tasks includes at least one of background detection, focal point detection, object detection, or human face recognition; and
wherein the characteristics of the respective tasks include at least a dependency of the respective tasks and respective estimated durations for performing the respective tasks by the one or more processing units in the system.

8. The method of claim 1, wherein the system is configured to perform inference operations of one or more machine learning models for processing a sequence of inputs, wherein each of the sequence of inputs is received at the host according to an order at a particular frequency, and wherein a time period of the recurring time window is determined based on the particular frequency.

9. The method of claim 1, wherein the first machine learning model comprises a neural network including multiple network layers arranged in a sequence, wherein obtaining the first estimated duration comprises:
for each layer of the network layers, determining a respective estimated layer duration for the system to perform respective layer operations specified in the layer for processing the input; and
aggregating the respective estimated layer durations for all network layers to obtain the first estimated duration.

10. The method of claim 2, further comprising:
performing inference operations associated with a first sub-model of the first group of sub-models according to the sequence in the first remaining time period of a first recurring time window of the plurality of recurring time windows, and
performing inference operations associated with a second sub-model of the first group of sub-models that succeeds the first sub-model according to the sequence in the first remaining time period of a second recurring time window of the plurality of recurring time windows.

11. The method of claim 9, wherein partitioning the first machine learning model comprising the neural network further comprises:
partitioning the neural network into the first group of sub-models, each including a respective number of network layers arranged according to the sequence; and
determining a respective fill layer for each sub-model of the first group of sub-models except for the first sub-model so that an intermediate output generated from another sub-model preceding the sub-model is provided to the sub-model as an input by the respective fill layer;
wherein the respective fill layers each are the first layer of network layers included in a corresponding sub-model of the first group of sub-models.

12. The method of claim 1, wherein the input comprises a sequence of inputs including a first input and a second input received at the host according to an order, wherein generating the inference output further comprises:
performing inference operations associated with a first sub-model according to the sequence for processing the first input to generate a first intermediate output;
providing the first intermediate output as a first intermediate input, through a fill layer for a second sub-model, to the second sub-model that succeeds the first sub-model according to the sequence; and
performing inference operations associated with the first sub-model according to the sequence for processing the second input to generate a second intermediate output, meanwhile, performing inference operations associated with the second sub-model for processing the first intermediate input.

13. The method of claim 2, wherein generating the first inference output further comprises:
storing an intermediate output generated by a sub-model of the first group of sub-models for processing the input at a memory unit in the system; and
retrieving, from the memory unit in the system, the intermediate output as an intermediate input for another sub-model that succeeds the sub-model according to the sequence.

14. A system comprising one or more computers and one or more storage devices storing instructions that when executed by one or more computers cause the one or more computers to perform respective operations, wherein the system further comprises a host and one or more hardware processing units configured to perform inference operations of a plurality of machine learning models, the operations comprising:
receiving, at the host, data representing a first machine learning model, wherein the first machine learning model comprises inference operations for processing an input to generate a first inference output;
obtaining a first estimated duration for the system to perform the inference operations of the first machine learning model for processing the input to generate the first inference output;
identifying a priority time period reserved for performing priority inference operations of a priority machine learning model during each occurrence of a recurring time window in which the one or more hardware processing units perform at least a portion of the inference operations of the plurality of machine learning models;
determining a first remaining time period of each occurrence of the recurring time window that remains after reserving the priority time period for performing the priority inference operations; determining whether the first estimated duration is greater than the first remaining time period;
in response to determining that the first estimated duration is greater than the first remaining time period, partitioning the first machine learning model into a first group of sub-models that have respective estimated durations that are less than or equal to the first remaining time period, wherein each sub-model of the first group of sub-models includes a respective portion of the inference operations of the first machine learning model; and
performing, by the one or more hardware processing units, inference operations of a sub-model in the first group of sub-models during the first remaining time period of an occurrence of the recurring time window.

15. The system of claim 14, wherein receiving data representing the first machine learning model further comprises:
receiving data representing a plurality of machine learning models, each of the plurality of machine learning models being configured to implement a respective task and including respective inference operations to be performed by the system for processing the input;
measuring a respective level of priority for each of the plurality of machine learning models based on characteristics of the respective tasks; and
selecting, as the first machine learning model, one machine learning model from the plurality of machine learning models based on the respective levels of priority.

16. The system of claim 14, further comprising:
receiving data representing a second machine learning model,
obtaining a second estimated duration for the system to perform the inference operations of the second machine learning model for processing the input to generate a second inference output;
determining a second remaining time period of each occurrence of the recurring time window that remains after reserving (i) the priority time period for performing the priority inference operations and (ii) at least a respective estimated duration for performing inference operations of a sub-model in the first machine learning model;
determining whether the second estimated duration is greater than the second remaining time period;
in response to determining that the second estimated duration is greater than the second remaining time period, partitioning the second machine learning model into a second group of sub-models that have respective estimated durations that are less than or equal to the second remaining time period, wherein each sub-model of the second group of sub-models includes a respective portion of the inference operations of the second machine learning model; and
performing, by the one or more processing units, inference operations of a sub-model of the second group of sub-models during the second remaining time period of an occurrence of the recurring time window.

17. The system of claim 15, wherein the input includes an image frame of a plurality of image frames captured by a sensor;
wherein each occurrence of the recurring time window corresponds to the image frame of the plurality of image frames;
wherein the respective tasks includes at least one of background detection, focal point detection, object detection, or human face recognition; and
wherein the characteristics of the respective tasks include at least a dependency of the respective tasks and respective estimated durations for performing the respective tasks by the one or more processing units in the system.

18. One or more computer-readable storage media storing instructions that when executed by one or more computers cause the one or more computers to perform respective operations performed by a system including a host and one or more hardware processing units configured to perform inference operations of a plurality of machine learning models, the respective operations comprising:
receiving, at the host, data representing a first machine learning model, wherein the first machine learning model comprises inference operations for processing an input to generate a first inference output;
obtaining a first estimated duration for the system to perform the inference operations of the first machine learning model for processing the input to generate the first inference output;
identifying a priority time period reserved for performing priority inference operations of a priority machine learning model during each occurrence of a recurring time window in which the one or more hardware processing units perform at least a portion of the inference operations of the plurality of machine learning models;
determining a first remaining time period of each occurrence of the recurring time window that remains after reserving the priority time period for performing the priority inference operations; determining whether the first estimated duration is greater than the first remaining time period;
in response to determining that the first estimated duration is greater than the first remaining time period, partitioning the first machine learning model into a first group of sub-models that have respective estimated durations that are less than or equal to the first remaining time period, wherein each sub-model of the first group of sub-models includes a respective portion of the inference operations of the first machine learning model; and
performing, by the one or more hardware processing units, inference operations of a sub-model in the first group of sub-models during the first remaining time period of an occurrence of the recurring time window.

19. The one or more computer-readable storage media of claim 18, wherein receiving data representing the first machine learning model further comprises:
receiving data representing a plurality of machine learning models, each of the plurality of machine learning models being configured to implement a respective task and including respective inference operations to be performed by the system for processing the input;
measuring a respective level of priority for each of the plurality of machine learning models based on characteristics of the respective tasks; and
selecting, as the first machine learning model, one machine learning model from the plurality of machine learning models based on the respective levels of priority.

20. The one or more computer-readable storage media of claim 18, further comprising:
receiving data representing a second machine learning model,
obtaining a second estimated duration for the system to perform the inference operations of the second machine learning model for processing the input to generate a second inference output;
determining a second remaining time period of each occurrence of the recurring time window that remains after reserving (i) the priority time period for performing the priority inference operations and (ii) at least a respective estimated duration for performing inference operations of a sub-model in the first machine learning model;
determining whether the second estimated duration is greater than the second remaining time period;
in response to determining that the second estimated duration is greater than the second remaining time period, partitioning the second machine learning model into a second group of sub-models that have respective estimated durations that are less than or equal to the second remaining time period, wherein each sub-model of the second group of sub-models includes a respective portion of the inference operations of the second machine learning model; and
performing, by the one or more processing units, inference operations of a sub-model of the second group of sub-models during the second remaining time period of an occurrence of the recurring time window.
